(19) United States
(12) Patent Application Publication
(10) Pub. No.: US 2026/0249773 A1
(43) Pub. Date: Aug. 27, 2026

(54) SHAPE-CHANGING CARGO BLANKET AND TONNEAU COVER

(71) Applicant: Toyota Motor Engineering & Manufacturing North America, Inc., Plano, TX (US)

(72) Inventors: Yuyang Song, Ann Arbor, MI (US); Koray Benli, Ann Arbor, MI (US); Shinnosuke Shimokawa, Ann Arbor, MI (US); Umesh N. Gandhi, Farmington Hills, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/062,144

(22) Filed: Feb. 25, 2025

(51) Int. Cl. B60P 7/06; B60P 7/08

(52) U.S. Cl. CPC B60P 7/065; B60P 7/0876

(57) ABSTRACT

Embodiments described herein relate to covers. In one embodiment, a shape-changing cargo blanket and tonneau cover includes a jamming component. The jamming component includes a sleeve and jamming layers housed within the sleeve that cause the jamming component to become rigid when the sleeve is substantially under vacuum. The cover conforms to a shape of an item when in a flexible state and becomes rigid in the shape when substantially under vacuum.

### TECHNICAL FIELD

The subject matter described herein relates, in general, to covers and, more particularly, to a shape-changing, dual-purpose cover that serves as both a cargo blanket and a tonneau cover.

### BACKGROUND

Some vehicles include cargo areas equipped to store one or more cargo items such as luggage, sports equipment, etc. These cargo areas include trunks, truck beds, etc., and are typically large open storage spaces. Oftentimes, however, items stored in these cargo areas are not secured to the interior of the vehicle. As a result, the items may shift and slide within the cargo area while the vehicle is in motion, which may cause damage to the items and/or the vehicle itself.

To protect items within cargo areas of vehicles, some vehicles come equipped with cargo blankets. However, cargo blankets are designed to protect cargo items from extreme temperatures, and do not prevent cargo items from moving within a vehicle. Moreover, some vehicles such as pickup trucks include tonneau covers. However, like cargo blankets, tonneau covers are designed to protect cargo items from the external environment of the vehicle, and do not prevent movement of cargo items. Moreover, cargo blankets and tonneau covers are large, bulky, and difficult to use and store.

### SUMMARY

Example systems and other embodiments relate to a cover that serves as both a cargo blanket and a tonneau cover. As mentioned above, some vehicles include equipment for storing, protecting, and securing cargo items within a cargo area of the vehicle, such as a trunk or truck bed. However, many of these items of equipment do not sufficiently protect or secure cargo items. Accordingly, embodiments described herein are directed to a cover that serves as a cargo blanket or a tonneau cover to cover and secure cargo items within a vehicle. The cover is configured to change shape to conform to cargo items of varying dimensions, and the cover is also configured to change in rigidity as well by being flexible or rigid. When the cover is flexible, the cover can conform to an item, for example, a stack of cargo boxes in a vehicle trunk. When the cover is rigid, the cover facilitates securement of the items by preventing the items from substantially moving. In another example, when the cover is flexible, the cover can change shape to conform to openings of truck beds of various dimensions, and when the cover is rigid, the cover can serve as a tonneau cover for a truck bed. As a result, the cover can be used in multiple different ways in conjunction with the vehicle to cover, protect, and/or secure cargo items within the vehicle.

In one embodiment, a cover is disclosed. The cover includes a jamming component. The jamming component includes a sleeve and jamming layers housed within the sleeve that cause the jamming component to become rigid when the sleeve is substantially under vacuum. The cover conforms to a shape of an item when in a flexible state and becomes rigid in the shape when substantially under vacuum.

In another embodiment, an apparatus is disclosed. The apparatus includes a cover including a jamming component. The jamming component includes a sleeve and jamming layers housed within the sleeve that cause the jamming component to become rigid when the sleeve is substantially under vacuum. One or more of the jamming layers includes an array of tiles flexibly interconnected by hinges. The cover also includes a membrane that is flexible and connected to the jamming component. The membrane defines an inflation chamber that is inflatable separately from the sleeve. The cover conforms to a shape of an item when in a flexible state and becomes rigid in the shape when substantially under vacuum, and the membrane is inflatable to provide additional securement to the item.

In yet another embodiment, a system is disclosed. The system includes a cover including a jamming component. The jamming component includes a sleeve and jamming layers housed within the sleeve that cause the jamming component to become rigid when the sleeve is substantially under vacuum. One or more of the jamming layers includes an array of tiles flexibly interconnected by hinges. The tiles have a shape that is substantially rhomboidal such that the jamming layers fold along the hinges according to a crease pattern with various degrees of folding such that the cover covers items of varying dimensions. The tiles are formed of a substantially rigid material to provide rigidity to the cover in combination with the jamming layer when the cover is under vacuum. The hinges are formed of a flexible material to allow the cover to conform to a shape of an item. The cover conforms to the shape when in a flexible state and becomes rigid in the shape when substantially under vacuum.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1A illustrates one example of a cover used as a cargo blanket, where the cargo blanket is expanded over cargo items in a vehicle.

FIG. 1B illustrates one example of a cover used as a cargo blanket, where the cargo blanket is draped over cargo items in a vehicle.

FIG. 1C illustrates one example of a cover used as a cargo blanket, where the cargo blanket is activated to secure cargo items in a vehicle.

FIG. 2 illustrates one example of a cover used as a tonneau cover for a truck bed.

FIG. 3 illustrates one example of a membrane of a cover that is inflated to secure a cargo item in a vehicle.

FIG. 4A illustrates one example of a cross-section of a cover when the cover is flexible.

FIG. 4B illustrates one example of a cross-section of a cover when the cover is rigid.

FIG. 5A illustrates a first example of a topside of a cover when the cover is partially folded.

FIG. 5B illustrates a first example of a bottom side of a cover when the cover is partially folded.

FIG. 5C illustrates a second example of a topside of a cover when the cover is partially folded.

FIG. 5D illustrates a second example of a bottom side of a cover when the cover is partially folded.

FIG. 6 illustrates one example of a cover when the cover is folded.

### DETAILED DESCRIPTION

Various embodiments associated with a shape-changing, dual-purpose cover are disclosed herein. As mentioned above, some vehicles include equipment for storing, protecting, and securing cargo items within a cargo area of the vehicle, such as a trunk or truck bed. However, many of these items of equipment do not sufficiently protect or secure cargo items. Accordingly, embodiments herein are directed to a cover that serves as a cargo blanket or a tonneau cover to cover and secure cargo items within a vehicle. The cover is configured to change shape to conform to cargo items of varying dimensions, and the cover is also configured to change in rigidity as well by being flexible or rigid. When the cover is flexible, the cover can conform to an item, for example, a stack of cargo boxes in a vehicle trunk. When the cover is rigid, the cover facilitates securement of the items by preventing the items from substantially moving. In another example, when the cover is flexible, the cover can change shape to conform to openings of truck beds of various dimensions, and when the cover is rigid, the cover can serve as a tonneau cover for a truck bed. As a result, the cover can be used in multiple different ways in conjunction with the vehicle to cover, protect, and/or secure cargo items within the vehicle.

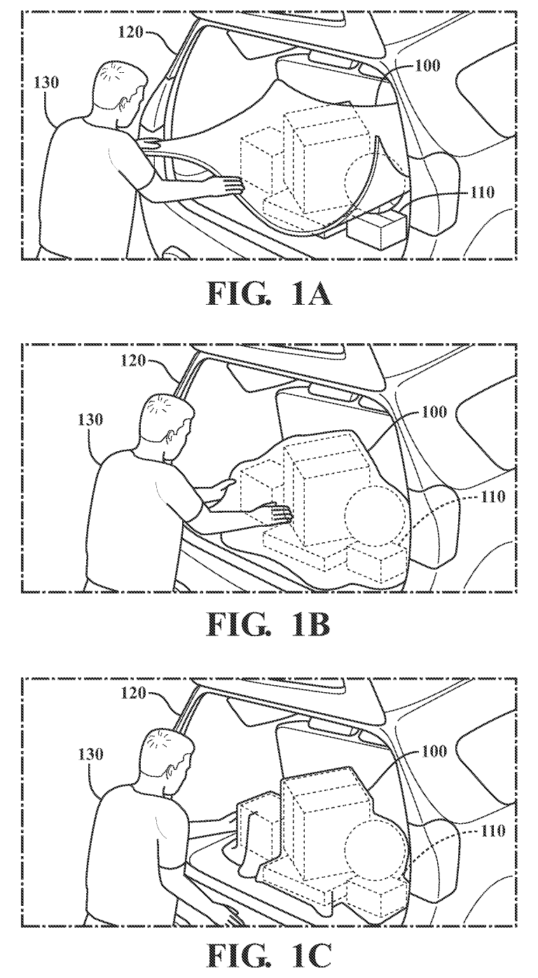

Referring now to FIGS. 1A-1C, a first implementation of a cover 100 is shown. In this implementation, the cover 100 is used as a cargo blanket. In other words, the cover 100 is used to cover, protect, and/or secure one or more cargo items 110. In some instances, the cargo items 110 are items located in a cargo area of a vehicle 120 (e.g., a trunk of the vehicle 120). The cargo items 110 can include boxes, sports equipment, luggage, and/or other items that a user may need to store and/or transport in the vehicle 120. In any case, a user 130 can expand the cover 100 over the cargo items 110, as shown in FIG. 1A, drape the cover 100 over the cargo items 110, as shown in FIG. 1B, and activate the cover 100 to secure the cargo items 110, as shown in FIG. 1C and as described in further detail below. Before activation of the cover 100 to secure the cargo items 110, the cover 100, in one embodiment, is flexible, for example, as shown in FIGS. 1A and 1B. When activated, for example, as shown in FIG. 1C, the cover 100 becomes rigid and conforms to an outer surface of the cargo items 110. As a result, the cover 100 helps to secure the cargo items 110 within the cargo area, for example, by preventing shifting of the cargo items 110 with respect to one another, and/or by preventing shifting of the cargo items 110 within the cargo space. As mentioned above, activation of the cover 100 as well as further details of the cover 100 will be described in further detail below.

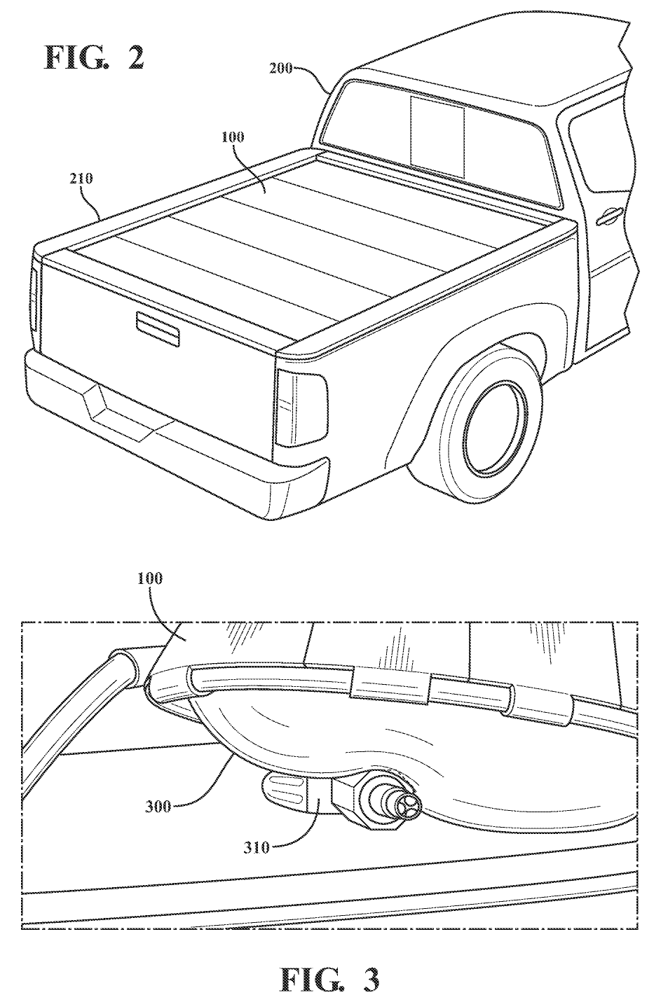

Referring now to FIG. 2, a second implementation of the cover 100 is shown. In this implementation, the cover 100 is used as a tonneau cover, for example, for a pickup truck 200 having a cargo area which is a bed 210. When the cover 100 is activated, as mentioned above, the cover 100 can become rigid and thus can serve as a hard, flat tonneau cover for the pickup truck 200 to cover the bed 210 and cargo items stored within the bed 210. As a result, the cover 100 can protect the bed 210 and cargo items stored within the bed 210 from environmental elements, from theft, etc., and the cover 100 can also support items placed on top of the bed 210, for example, for additional storage on the pickup truck 200. When the cover 100 is flexible, the cover 100 is configured to change shape, for example, by expanding or collapsing, to conform to pickup truck beds having various dimensions, as described in further detail below.

In some arrangements, when the cover 100 is used either as a cargo blanket or as a tonneau cover, it may be advantageous to provide additional securement to cargo items located in the cargo area (e.g., a trunk of the vehicle 120, the bed 210 of the pickup truck 200, etc.). For example, when the cover 100 is used as a cargo blanket, the cargo items may include small cargo items located between larger cargo items that, when the cover 100 is activated, the cover 100 may not touch, as the cover 100 may conform to the outer surface of the group of cargo items. Similarly, when the cover 100 is used as a tonneau cover, cargo items in the bed 210 may be susceptible to shifting around within the bed 210 underneath the cover 100. Accordingly, in various implementations, the cover 100 includes an inflatable component that can be inflated to contact and secure cargo items. Referring now to FIG. 3, in some arrangements, the inflatable component is a membrane 300. In one arrangement, the membrane 300, as described in further detail below, is inflatable such that the membrane 300 contacts a cargo item such as a tool 310. When the membrane 300 is inflated, the membrane 300 can contact the tool 310 to secure the tool 310 within the cargo area, for example, against an interior surface of the vehicle 120 or against a floor of the bed 210. Further details of the membrane 300 will be described in further detail below.

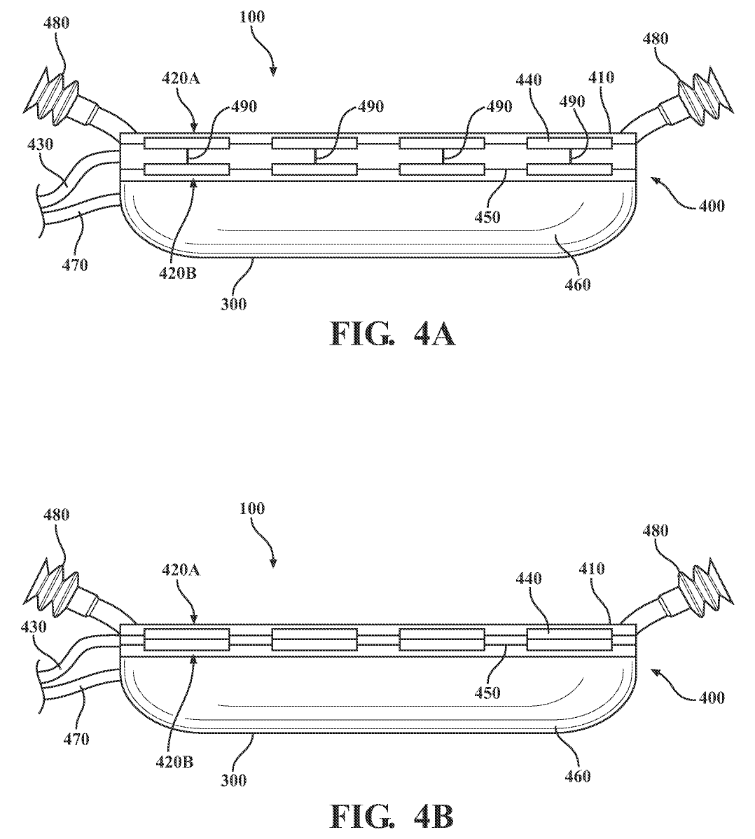

Referring now to FIGS. 4A and 4B, additional components of the cover 100 will now be described. In addition to the membrane 300, in one embodiment, the cover 100 includes a jamming component 400. As mentioned above, the cover 100 can be activated to become rigid. The jamming component 400, in one arrangement, causes the cover 100 to become rigid and also allows the cover 100 to become flexible. In one embodiment, the jamming component 400 includes a sleeve 410 that houses jamming layers 420 (for example, a first jamming layer 420A and a second jamming layer 420B), and, in one or more embodiments, the jamming component 400 includes a jamming port 430. The sleeve 410, in one implementation, is flexible and formed of a thin material such that, when the cover 100 is flexible, the sleeve 410 does not unduly prohibit movement of the cover 100. For example, the sleeve 410 can be formed of a flexible, lightweight plastic material. Referring to the jamming port 430, the jamming port 430 is in fluidic communication with the sleeve 410 and is configured to add or remove fluid to and from the sleeve 410. As described herein, the fluid is air, but it should be understood that, in other embodiments, the fluid may be another gas or even a liquid such as water. In any case, when the sleeve 410 is substantially under vacuum, for example, as shown in FIG. 4B, air is pulled out of the sleeve 410, causing the jamming layers 420 to contact each other. Friction between the jamming layers 420, when pressed together when the sleeve 410 is substantially under vacuum, causes the jamming component 400 to become rigid. The user 130 can activate the cover 100 to become rigid by activating the jamming port 430, as described in further detail below. Contrariwise, when the sleeve 410 is not substantially under vacuum, for example, as shown in FIG. 4A, air enters the sleeve 410 and allows the jamming layers 420 to separate, thereby reducing the friction between the jamming layers 420 and allowing the jamming component 400 to become flexible, as described in further detail below.

As mentioned above, the jamming layers 420 include a first jamming layer 420A and a second jamming layer 420B. While FIG. 4A and 4B depict a cover 100 having two jamming layers 420, it should be understood that the cover 100 can include additional jamming layers 420 as well. For example, the cover 100 can include three jamming layers 420, four jamming layers 420, five jamming layers 420, and so on. In any case, one or more of the jamming layers 420 includes an arrangement of tiles 440 interconnected to each other by hinges 450. In one arrangement, the tiles 440 are formed of a substantially rigid material and are not in and of themselves flexible. In one approach, the tiles 440 are formed from hard plastic, but can also be made of other substantially rigid materials such as metal, wood, etc. Moreover, all of the tiles 440 can be formed of the same rigid material, or some of the tiles 440 can be formed of a different rigid material. In any case, due to being formed of a rigid material, the tiles 440 impart rigidity to the cover 100, especially when the cover 100 is activated.

On the other hand, the hinges 450 impart flexibility to the cover 100. In one approach, the hinges 450 are formed of a flexible material. In one example, the hinges 450 are formed from soft plastic, but can also be made of other flexible materials such as rubber, paper, etc. In any case, the hinges 450 connect the tiles 440 to each other such that the tiles 440 form a set arrangement of tiles 440, while imparting flexibility to the cover 100 when the cover 100 is not activated to become rigid. As a result, the cover 100 can be draped over cargo items, as shown in FIG. 1B, or the cover 100 can be shaped according to the dimensions of a truck bed, as shown in FIG. 2 and as described in further detail below.

As mentioned above, in some instances, the tiles 440 are formed of a substantially rigid material while the hinges 450 are formed of a flexible material. In some instances, the tiles 440 and the hinges 450 are formed of the same material, and the tiles 440 are made rigid by having a greater thickness or greater amount of the material than the hinges 450. For example, the tiles 440 and the hinges 450 can be 3D-printed from plastic, and the tiles 440 are printed with enough plastic to make the tiles 440 rigid, while the hinges 450 are printed from a smaller amount of plastic to make the hinges 450 flexible. However, the tiles 440 and the hinges 450, in other instances, are formed of different materials. Moreover, in some arrangements, the tiles 440 and the hinges 450 are unitarily formed. For example, in one approach, the tiles 440 and the hinges 450 are unitarily formed using 3D-printing. In other arrangements, the tiles 440 and the hinges 450 are formed separately and are later connected together.

Moreover, the tiles 440, in one embodiment, are about a few centimeters or a few inches in length and/or width. For example, the tiles 440 can be about two inches in length and/or width, about four inches in length and/or width, about three centimeters in length and/or width, and so on. This size range allows the tiles 440 to provide the necessary rigidity when the cover 100 is substantially under vacuum while maintaining sufficient flexibility when the cover 100 is flexible. However, it should be understood that the dimensions of the tiles 440 are not limited to this range and can be adjusted based on specific application requirements. For instance, larger tiles 440 may be used for applications requiring greater coverage and rigidity, while smaller tiles 440 may be advantageous for applications necessitating finer conformability to intricate shapes.

It should be noted that FIGS. 4A and 4B depict a cross-sectional, schematic view of the cover 100. While FIGS. 4A and 4B show two jamming layers 420 each having four tiles 440 and five hinges 450 each, it should be understood that this is merely one possible arrangement of tiles 440 and hinges 450. In other arrangements, the jamming layers 420 can have another number of tiles 440 and hinges 450. More specifically, in other arrangements, the jamming layers 420 can have tens, dozens, or even hundreds of tiles 440 and hinges 450. The number of tiles 440 and hinges 450, in some instances, may be chosen based on the size of the tiles 440 and on the size of the cargo items and/or truck bed with which the cover 100 is intended to be used.

In some instances, to further impart structural rigidity to the cover 100, the tiles 440 of one jamming layer may be connected to the tiles 440 of another jamming layer. For example, as shown in FIG. 4A, the tiles 440 of the first jamming layer 420A may be connected to the tiles 440 of the second jamming layer 420B. Connecting the jamming layers 420A and 420B in this manner helps to maintain the structural integrity of the components of the cover 100, as described in further detail below. In one approach, for example, as shown in FIG. 4A, the jamming layers 420A and 420B may be connected by tethers 490. The tethers 490, in one embodiment, are inelastic and inextensible so that the movement of the jamming layers 420 and 420B with respect to each other is limited. For example, the tethers 490 can be formed of cord, rope, string, nylon, fishing line, carbon fiber threads, or another inextensible material. Moreover, while FIG. 4A shows four tethers 490 (e.g., one tether 490 per pair of tiles 440), it should be understood that the cover 100 can include another suitable number of tethers 490. For example, the cover 100 can include two, three, four, or even more tethers 490 per pair of tiles 440, or the cover 100 can include one tether 490 for every two or three or more pairs of tiles 440.

In any case, the tethers 490 help to control the deployment of the cover 100 by a user. As mentioned above, a user can stretch and drape the cover 100 over a group of cargo items 110 so that the cover 100 can be used to secure the cargo items 110. In some instances, though, a user may struggle to lay the cover 100 over the cargo items 110, for example, if the user has limited mobility and/or strength. Accordingly, in one embodiment, the cover 100 can be expanded by inflating the sleeve 410 via the inflation port 430. As the sleeve 410 is inflated, the sleeve 410 expands, thereby stretching out the cover 110. As the sleeve 410 inflates, the sleeve 410 would balloon out as a function of the increasing pressure. However, the tethers 490 substantially prevent ballooning of the sleeve 410, as the tethers retain the jamming layers 420A and 420B in a substantially planar configuration as shown in FIGS. 4A and 4B. As a result, the cover 100 can be automatically expanded via the inflation port 430 while the cover 100 retains a substantially flat configuration that is suitable for draping the cover 100 over a large area.

With continued reference to FIGS. 4A and 4B, the cover 100 also includes the membrane 300, as mentioned above. The membrane 300, in one arrangement, is connected to the jamming component 400. The membrane 300 is flexible and defines an inflation chamber 460 that is inflatable and deflatable. In one arrangement, the inflation chamber 460 is inflatable and deflatable separately from the sleeve 410 via an inflation port 470 that is in fluidic communication with the inflation chamber 460. As described herein, the inflation port 470 is configured to inflate and deflate the inflation chamber 460 by respectively adding and removing air from the inflation chamber 460. However, it should be understood that other fluids such as other gasses or liquids may be used to inflate and deflate the inflation chamber 460. In any case, the membrane 300, in some implementations, is formed of a durable material that is suitable for contacting and securing cargo items while still being flexible and stretchy enough to conform to those cargo items without puncturing. For example, the membrane 300 can be formed of a durable, stretchy, flexible rubber or cloth material.

In any case, the membrane 300 can be utilized when the cover 100 serves either as a cargo blanket or as a tonneau cover. In the former implementation, such as is shown in FIGS. 1A-1C, when the cover 100 is laid over the cargo items 110, there may be space between some of the cargo items 110 and the cover 100, especially when there are large cargo items 110 placed near small cargo items 110. Accordingly, in this instance, the user 130 can activate the membrane 300 to become inflated so that the membrane 300 extends below the cover 100 and contacts the smaller cargo items 110, which may help hold the smaller cargo items 110 in place. Similarly, when the cover 100 is used as a tonneau cover, as shown in FIG. 2 for example, a user can activate the membrane 300 to become inflated so that the membrane 300 extends into the bed 210 of the pickup truck 200 to contact cargo items stored within the bed 210 to hold the cargo items substantially in place to prevent the cargo items from shifting within the bed 210.

As mentioned above, the cover 100 may not only help to secure cargo items but may also be secured itself to prevent the cover 100 from substantially moving, thereby providing even further securement to the cargo items. Accordingly, with continued reference to FIGS. 4A and 4B, in one embodiment, the cover 100 also includes suction cups 480. In instances in which the cover 100 is used as a cargo blanket, the suction cups 480 can be secured to an interior surface of the vehicle 120 to retain the cover 100 in place and thereby provide additional protection to the cargo items 110 against shifting within the cargo space. For example, the suction cups 480 can be secured to the floor of the trunk of the vehicle 120 or even to other surfaces within the vehicle 120 such as seat surfaces, walls, windows, pillars, etc. In this way, the cover 100 can be secured in place within the cargo space and substantially prevent shifting of the cargo items. Similarly, when the cover 100 is used as a tonneau cover, the suction cups 480 can be suctioned to the sidewalls of the bed 210 or even to other surfaces of the pickup truck 200 such as a rear window of the pickup truck 200, a tailgate of the pickup truck 200, etc.

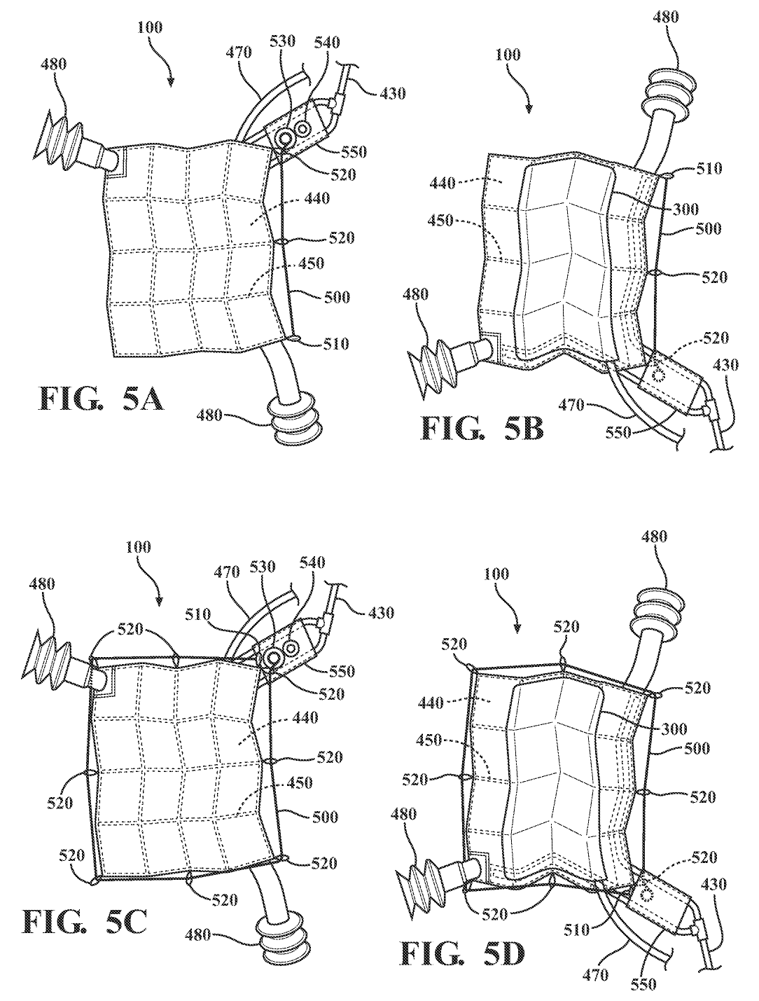

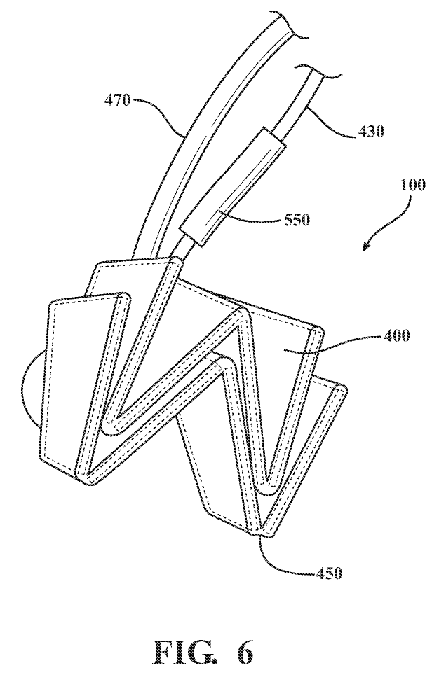

Additional aspects of the components of the cover 100 will now be described with reference to FIGS. 5A-5C. FIGS. 5A and 5B depict the cover 100 when the cover 100 is partially folded. The cover 100 can achieve a partially folded configuration via the hinges 450, and in some instances, via the shapes of the tiles 440. More specifically, in one arrangement, the tiles 440 are generally rhomboidal. A rhomboidal shape of the tiles 440, in one implementation, allows the cover 100 to fold along the hinges 450 according to a crease pattern with various degrees of folding. The crease pattern may resemble paper origami. Moreover, the various degrees of folding are achieved, in one implementation, by the flexibility of the hinges 450. For example, the hinges 450 of the cover 100 as illustrated in FIGS. 5A and 5B may be folded at about a 30 degree angle from the tiles 440. As a result, the cover 100 is partially folded. Referring back to FIGS. 4A and 4B, the hinges 450 are substantially parallel with the tiles 440, and thus the cover 100 is flat and is not substantially folded. On the other hand, as shown in FIG. 5C, the cover 100 is completely folded up into a compact size, which may be advantageous for storing the cover 100, for example, in a compartment of the vehicle 120 or pickup truck 200.

While the tiles 440 are shown in FIGS. 5A-5C as having a generally rhomboidal shape, it should be noted that the tiles 440, in other embodiments, have different shapes. For example, in other implementations, the tiles 440 can have generally square shapes, triangular shapes, circular shapes, pentagonal shapes, etc. Additionally, while the tiles 440 are shown in the figures as each have substantially the same shape and size, it should be understood that the tiles 440 do not all have to have the same shape and size. For example, an exemplary array of tiles 440 can include tiles 440 of both square and triangular shapes. In another example, an array of tiles 440 can include large tiles 440 and small tiles 440.

In any case, the tiles 440 are configured to fold about the hinges 450 such that the cover 100 can cover items having various dimensions. For example, the user 130 can stretch the cover 100 out to be unfolded to cover large items, or the user 130 can fold the cover 100 up to a smaller size to cover smaller items. Referring back to FIGS. 1A-1C, in one implementation, the user 130 can unfold and/or inflate the cover 100 to cover the cargo items 110 stored in the vehicle 120. The user 130 can then drape the cover 100 over the cargo items 110 when the cover 100 is flexible so that the cover 100 conforms to the outer surface of the cargo items 110. Then the user 130 can activate the cover 100 to cause the jamming component 400 to become substantially under vacuum, thereby causing the jamming component 400 to become rigid in the shape of the outer surface of the cargo items 110. In this implementation, the jamming component 400 becomes rigid when the tiles 440 are folded about the hinges 450 according to the outer surface of the cargo items 110. Thus, the jamming component 400, when substantially under vacuum when the tiles 440 are partially folded, becomes rigid in a partially folded shape, thereby preventing the tiles 440 from further folding or unfolding. As a result, the size of the cover 100 is set according to the cargo items 110, and thus the cover 100 secures the cargo items 110 substantially in place within the vehicle 120.

In some embodiments, the cover 100 includes additional components that help to secure cargo items 110 as described above. For example, referring to FIGS. 5A-5D, in one approach, the cover 100 includes a drawstring 500. The drawstring 500 can be leveraged to cinch the cover 100 around the cargo items 110 to further secure the cargo items 110. As such, the drawstring 500, in one approach, is formed of an inelastic, inextensible material. For example, the drawstring 500 can be formed of cord, rope, string, nylon, fishing line, carbon fiber, etc. In any case, the drawstring 500 is connected to an outer perimeter of the cover 100. As shown in FIGS. 5A and 5B, the drawstring 500 is connected to a single side of the cover 100, while FIGS. 5C and 5D show the drawstring 500 connected around the entire perimeter of the cover 100. In the first arrangement, even though the drawstring 500 is only provided on one side of the cover 100, cinching the drawstring 500 still folds the entire cover 100 due to the structure and manner in which the tiles 440 fold. In the second arrangement, providing the drawstring 500 along the entire perimeter of the cover 100 facilitates stronger and faster cinching of the cover 100.

In either arrangement or in other arrangements, the drawstring 500 can be connected to the cover 100 at a connection point. At the connection point, in one example, the drawstring 500 can be connected to a tab 510 that is attached to the cover 100. In other examples, the drawstring 500 can be directly connected to the cover 100 or to another component connected to the cover 100. Additionally, the cover 100 can include grommets 520 that connect the drawstring 500 to the cover 100 while allowing the cover 100 and the drawstring 500 to move with respect to each other. As shown in FIGS. 5A and 5B, the cover 100 includes two grommets 520, and as shown in FIGS. 5C and 5D, the cover 100 includes 8 grommets 520. However, the cover 100 may include another number of grommets 520, for example, a number of grommets 520 needed to secure the drawstring 500 to the cover 100.

In any case, the cover 100 includes a mechanism that operates the drawstring 500. In one embodiment, the mechanism is a spring-loaded mechanism that biases the drawstring 500 in a cinched position in which the cover 100 is folded (as shown in FIG. 6). Biasing the drawstring 500 to a cinched position provides the benefits of auto-stowing the cover 100 in a folded configuration for easy storing and so that the user does not have to manually fold the cover, while also cinching the cover 100 around cargo items 110. In another embodiment, the mechanism can contract the drawstring 500 on demand, for example, by a button.

One example of the mechanism is shown in FIGS. 5A and 5C. As shown, in one approach, the mechanism includes a first spool 530 and a second spool 540. In one embodiment, the first spool 530 is free to rotate while the second spool 540 is stationary. The first spool 530 can be used to help guide the drawstring 500 into the second spool 540 and can also be used to compactly store the drawstring 500. The second spool 540, in one embodiment, includes a spring-loaded mechanism, as mentioned above. In one approach, the spring-loaded mechanism is a heat-treated spring steel. The heat-treated spring steel allows the drawstring 500 to be pulled out of the mechanism while biasing the drawstring 500 back to a stowed position in which the drawstring 500 is coiled with the heat-treated spring steel. In addition to the first spool 530 and the second spool 540, the mechanism can also include a housing 550. In one embodiment, the housing 550 stores the first spool 530 and the second spool 540.

In instances in which the drawstring 500 is biased to a stowed position, as mentioned above, the cover 100 is biased to the folded configuration as shown in FIG. 6. Accordingly, when a user wants to use the cover 100 to secure cargo items 110 as shown in FIGS. 1A-1C, the user can pull open the cover 100 or inflate the sleeve 410 as mentioned above to expand the cover 100, drape the cover 100 over the cargo items 110, activate the sleeve 410 to be vacuumed, and then release the cover 100 to simultaneously cause the cover 100 to become rigid in the shape of the cargo items 100 and cause the cover 100 to become cinched around the cargo items 110, thereby securing the cargo items 110. In some instances, prior to pulling open the cover 100 or inflating the sleeve 410 to expand the cover 100, the user may want to temporarily disable the auto-stowing mechanism to facilitate expansion of the cover 100. Accordingly, in one embodiment, the mechanism includes a trigger that prevents the drawstring 500 from being biased in the stowed, coiled position. The trigger can be a physical trigger or an electrical trigger. This facilitates a user to more easily cover an item with the cover 100.

While the item covered by the cover 100 as shown in FIGS. 1A-1C is a group of cargo items 110, it should be understood that, as mentioned above, the item can be another item that may benefit from one or more of the functions of the cover 100. For example, referring now to FIG. 2, in another implementation, the item may be the bed 210 of the pickup truck 200. In this implementation, the cover 100 can advantageously provide cover and protection to the bed 210 and any items that may be stored within the bed 210. More specifically, a user can unfold the cover 100 over the bed 210 until the hinges 450 fold such that the size of the cover 100 substantially matches the size of the bed 210 (or, more specifically, an opening of the bed 210). The user can then activate the cover 100 to cause the jamming component 400 to become rigid, thereby preventing the tiles 440 from further folding or unfolding, and thus setting the size of the cover 100 according to the opening of the bed 210 to securely fit the cover 100 to the opening.

With continued reference to FIG. 2 as well as FIGS. 1A-1C, in some instances, a user may wish to cover 100 and secure items of varying sizes, as mentioned briefly above. For example, a group of cargo items 110 may include both large cargo items 110 such as large boxes as well as smaller cargo items 110 like a soccer ball. Accordingly, in another embodiment, the cover 100 can define compartments with differently sized and/or shaped tiles 440 that are configured to conform to items of varying sizes and/or shapes. For example, as shown in FIG. 2, the cover 100 may define five separate compartments. Two or more of the compartments may have tiles 440 of different sizes and/or shapes. For example, one compartment may have relatively larger tiles 440 that are generally rhomboidal in shape, which may be advantageous for securing large cargo items. In another example, another compartment may have relatively smaller tiles 440 that are generally triangular or circular in shape, which may be advantageous for securing small cargo items. Moreover, the shape of the tiles 440 may affect the rigidity of the cover 100 when the cover 100 is substantially under vacuum. For example, tiles 440 having a rhomboidal shape may have a higher rigidity than tiles 440 having a circular shape. Accordingly, the cover 100 can include compartments having differently shaped tiles according to how much securement of the cargo items is needed, the size and/or weight of the cargo items, and other factors.

In any case, whether or not the cover 100 includes compartments and/or tiles 440 of different sizes or shapes, in various embodiments, the cover 100 can include an integrated power source, such as a battery, to facilitate the activation of the jamming port 430 and/or the inflation port 470. This power source is electrically connected to the jamming port 430 and/or the inflation port 470, enabling the user to easily control the inflation and deflation of the jamming component 400 and/or the membrane 300. The battery can be housed within a compartment of the cover 100, ensuring that it is protected from external elements and does not affect the flexibility or rigidity of the cover 100. By incorporating a battery, the cover 100 can be independently controlled without the need for an external power supply, thereby enhancing its portability and ease of use. However, it is understood than an external power supply can be used. In any case, the battery or power supply can be electrically connected to a battery of a vehicle when the cover 100 is used in connection with the vehicle.

In addition to the battery, in one approach, the cover 100 includes one or more switches designed to operate the battery, facilitating inflation and deflation of the jamming component 400 and/or the membrane 300 by a user. This switch(es) can be located on the cover 100 itself, within the cabin of a vehicle associated with use of the cover 100, or even on a remote control device. The switch(es) can be one or more physical buttons, toggle switches, or touch-sensitive panels. In some embodiments, the switch(es) may be integrated into a smartphone app, allowing for wireless control via Bluetooth or Wi-Fi. The switch(es) may communicate with the battery through a wired connection. Alternatively, in wireless configurations, the switch(es) can use low-power radio frequency (RF) signals to send commands to a receiver connected to the battery. The receiver can then activate the jamming port 430 and/or the inflation port 470 to inflate and deflate the sleeve 410 and/or the membrane 300.

While the arrangements described herein apply to a cover that can function as a cargo blanket or a tonneau cover, it should be understood that the cover is not limited to those implementations. In other embodiments, the cargo cover can be used as a sunshade, in-cabin divider, car cover, and other components as well. When used as a sunshade, a user can deploy the cover across an interior surface of a windshield of a vehicle when flexible and subsequently activate the cover to become rigid in the shape of the windshield. When used as an in-cabin divider, a user can position the cover within the cabin of a vehicle in the shape of a divider for the vehicle when flexible and subsequently activate the cover to become rigid in the shape of the divider. Finally, when used as a car cover, a user can drape the cover over a vehicle when flexible and subsequently activate the cover to become rigid in the shape of the vehicle.

The arrangements described herein provide the advantage of a shape-changing cover that can serve as a cargo blanket or a tonneau cover for a vehicle such as a pickup truck. The arrangements described herein also provide the advantage of a lightweight, flexible, and multi-purpose cover with freedom of usage in different sizes and shapes. Further, the arrangements described herein also provide the advantage of a multi-purpose cover with a compact configuration for easy storage, for example, within a compartment of a vehicle.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5C, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of… and…,” as used herein, refers to and encompasses any and all possible combinations of one or more of the associated listed items. As an example, the phrase “at least one of A, B, and C” includes A only, B only, C only, or any combination thereof (e.g., AB, AC, BC, OR ABC).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some examples, “substantially” can include being within normal manufacturing tolerances.

In this description, uses of “front,” “forward” and the like, and uses of “rear,” “rearward” and the like, refer to the longitudinal directions of the vehicle. “Front,” “forward,” and the like refer to the front (fore) of the vehicle, while “rear,” “rearward” and the like refer to the back (aft) of the vehicle. Uses of “side,” “sideways,” “transverse” and the like refer to the lateral directions of the vehicle, with “driver’s side” and the like referring to the left side of the vehicle, and “passenger side” and the like referring to the right side of the vehicle.

Aspects herein can be embodied in other forms without departing from the spirit or essential attributes thereof. Accordingly, reference should be made to the following claims, rather than to the foregoing specification, as indicating the scope thereof.

What is claimed is:

1. A cover, comprising:
a jamming component including:
a sleeve,
jamming layers housed within the sleeve that cause the jamming component to become rigid when the sleeve is substantially under vacuum; and
wherein the cover conforms to a shape of an item when in a flexible state and becomes rigid in the shape when substantially under vacuum.

2. The cover of claim 1, wherein one or more of the jamming layers include an array of tiles flexibly interconnected by hinges, wherein the tiles have a shape that is substantially rhomboidal such that the jamming layers fold along the hinges according to a crease pattern with various degrees of folding such that the cover covers items of varying dimensions.

3. The cover of claim 2, wherein the item is a truck bed, wherein the shape is an opening of the truck bed, and wherein the sleeve is substantially vacuumized in a partially folded state to prevent the tiles from further folding or unfolding, thereby setting a size of the cover according to the opening to securely fit the cover to the opening.

4. The cover of claim 1, wherein the item is one or more cargo items and wherein the shape is an outer surface of the one or more cargo items, and wherein the cover, when laid over the one or more cargo items in a flexible state, conforms to the outer surface and, when substantially under vacuum, becomes rigid in the shape of the outer surface to secure the one or more cargo items substantially in place.

5. The cover of claim 1, further comprising:
a drawstring connected to and extending along at least a portion of an outer perimeter of the cover, wherein the drawstring is connected to a spring-loaded mechanism that biases the drawstring into a coil, thereby biasing the cover into a folded configuration.

6. The cover of claim 1, wherein each jamming layer includes an array of tiles flexibly interconnected by hinges, wherein the sleeve defines at least a first compartment and a second compartment, wherein the first compartment and the second compartment respectively include a first set of jamming layers having relatively smaller tiles and a second set of jamming layers having relatively larger tiles, wherein the first compartment and the second compartment are configured to conform, respectively, to shapes of smaller items and larger items, thereby securing differently sized items when the sleeve is substantially under vacuum.

7. The cover of claim 1, further comprising two or more suction cups, wherein, when the item is one or more cargo items, the suction cups are suctioned to an interior surface of a cargo area of a vehicle to secure the one or more cargo items in place, and wherein, when the item is a truck bed, the suction cups are suctioned to a surface of the truck bed to secure the cover over an opening of the truck bed.

8. The cover of claim 1, wherein the tiles are interconnected by hinges and are formed of a substantially rigid material to provide rigidity to the cover in combination with the jamming layer when the cover is under vacuum, and wherein the hinges are formed of a flexible material to allow the cover to conform to the shape.

9. An apparatus, comprising:
a cover having a jamming component including:
a sleeve,
jamming layers housed within the sleeve that cause the jamming component to become rigid when the sleeve is substantially under vacuum, one or more of the jamming layers including an array of tiles flexibly interconnected by hinges; and
a membrane that is flexible and connected to the jamming component, the membrane defining an inflation chamber that is inflatable separately from the sleeve; and
wherein the cover conforms to a shape of an item when in a flexible state and becomes rigid in the shape when substantially under vacuum, and wherein the membrane is inflatable to provide additional securement to the item.

10. The cover of claim 9, wherein the tiles have a shape that is substantially rhomboidal such that the jamming layers fold along the hinges according to a crease pattern with various degrees of folding such that the cover covers items of varying dimensions.

11. The cover of claim 10, wherein the item is a truck bed, wherein the shape is an opening of the truck bed, and wherein the sleeve is substantially vacuumized in a partially folded state to prevent the tiles from further folding or unfolding, thereby setting a size of the cover according to the opening to securely fit the cover to the opening.

12. The cover of claim 9, where in the item is one or more cargo items and wherein the shape is an outer surface of the one or more cargo items, and wherein the cover, when laid over the one or more cargo items in a flexible state, conforms to the outer surface and, when substantially under vacuum, becomes rigid in the shape of the outer surface to secure the one or more cargo items substantially in place.

13. The cover of claim 9, wherein each jamming layer includes an array of tiles flexibly interconnected by hinges, wherein the sleeve defines at least a first compartment and a second compartment, wherein the first compartment and the second compartment respectively include a first set of jamming layers having relatively smaller tiles and a second set of jamming layers having relatively larger tiles, wherein the first compartment and the second compartment are configured to conform, respectively, to shapes of smaller items and larger items, thereby securing differently sized items when the sleeve is substantially under vacuum.

14. The cover of claim 9, further comprising two or more suction cups, wherein, when the item is one or more cargo items, the suction cups are suctioned to an interior surface of a cargo area of a vehicle to secure the one or more cargo items in place, and wherein, when the item is a truck bed, the suction cups are suctioned to a surface of the truck bed to secure the cover over an opening of the truck bed.

15. The cover of claim 9, wherein the tiles are interconnected by hinges and are formed of a substantially rigid material to provide rigidity to the cover in combination with the jamming layer when the cover is under vacuum, and wherein the hinges are formed of a flexible material to allow the cover to conform to the shape.

16. A system, comprising:
a cover having a jamming component including:
a sleeve,
jamming layers housed within the sleeve that cause the jamming component to become rigid when the sleeve is substantially under vacuum, one or more of the jamming layers including:
an array of tiles flexibly interconnected by hinges, the tiles having a shape that is substantially rhomboidal such that the jamming layers fold along the hinges according to a crease pattern with various degrees of folding such that the cover covers items of varying dimensions, the tiles being formed of a substantially rigid material to provide rigidity to the cover in combination with the jamming layer when the cover is under vacuum, the hinges being formed of a flexible material to allow the cover to conform to a shape of an item; and
wherein the cover conforms to the shape when in a flexible state and becomes rigid in the shape when substantially under vacuum.

17. The cover of claim 16, wherein the item is a truck bed, wherein the shape is an opening of the truck bed, and wherein the sleeve is substantially vacuumized in a partially folded state to prevent the tiles from further folding or unfolding, thereby setting a size of the cover according to the opening to securely fit the cover to the opening.

18. The cover of claim 16, where in the item is one or more cargo items and wherein the shape is an outer surface of the one or more cargo items, and wherein the cover, when laid over the one or more cargo items in a flexible state, conforms to the outer surface and, when substantially under vacuum, becomes rigid in the shape of the outer surface to secure the one or more cargo items substantially in place.

19. The cover of claim 16, wherein the jamming layers include a first jamming layer and a second jamming layer, and further comprising tethers connecting the first jamming layer and the second jamming layer, wherein, when the sleeve is inflated to expand the cover, the tethers retain the jamming layers in a substantially planar orientation with respect to each other, thereby causing the cover to expand in a substantially planar manner.

20. The cover of claim 16, further comprising two or more suction cups, wherein, when the item is one or more cargo items, the suction cups are suctioned to an interior surface of a cargo area of a vehicle to secure the one or more cargo items in place, and wherein, when the item is a truck bed, the suction cups are suctioned to a surface of the truck bed to secure the cover over an opening of the truck bed.
